(19) United States
(12) Patent Application Publication
(10) Pub. No.: US 2006/0081443 A1
(43) Pub. Date: Apr. 20, 2006

(54) Device and method for conveying transverse axially rod-shaped articles of the tobacco-processing industry

(75) Inventors: Karl-Heinz Pawelko, Marschacht (DE); Manfred Folger, Hamburg (DE); Franz Rottmann, Glinde (DE); Dieter Plaehn, Barum (DE)

Correspondence Address: GREENBLUM & BERNSTEIN, P.L.C., 1950 ROLAND CLARKE PLACE, RESTON, VA, 20191, US

(73) Assignee: HAUNI MASCHINENBAU AG, Hamburg (DE)

(21) Appl. No.: 11/245,181

(22) Filed: Oct. 7, 2005

(30) Foreign Application Priority Data
Oct. 14, 2004 (DE) 10 2004 050306.0

(51) Int. Cl. B65G 17/46

(52) U.S. Cl. 198/471.1

(57) ABSTRACT

The invention relates to a device and a method for conveying transverse axially rod-shaped articles of the tobacco-processing industry. The device includes at least one fluted conveyor device with flutes for the articles. In this manner, the width of the flutes is greater than the diameter of the articles and the flutes respectively have at least one suction boring that can be acted on with a vacuum for holding the articles by a vacuum at a position in the flute.

### CROSS-REFERENCE TO RELATED APPLICATIONS

The present application claims priority under 35 U.S.C. §119 of German Patent Application No. 10 2004 050 306.0, filed on Oct. 14, 2004, the disclosure of which is expressly incorporated by reference herein in its entirety.

### BACKGROUND OF THE INVENTION

1. Field of the Invention

The invention relates to a device and a method for conveying transverse axially rod-shaped articles of the tobacco-processing industry. The device comprises at least one fluted conveyor device with flutes for the articles, such that the width of the flutes is greater than the diameter of the articles and the flutes respectively have at least one suction boring that can be acted on with a vacuum for holding the articles by a vacuum at a position in the flute.

2. Discussion of Background Information

Rod-shaped articles of the tobacco-processing industry are understood to mean plain and filter cigarettes, cigarillos, cheroots, and other smokable articles of tobacco or tobacco substitutes, filter rods and the like.

Fluted conveyor devices for conveying rod-shaped articles of the tobacco-processing industry are known, in particular fluted drums and fluted belts in which the width of the flutes is greater than an article diameter. During the conveyance of the articles in the flutes of the fluted conveyor device, the articles are held in their position by a vacuum applied to suction borings in the flutes. However, for example, during a transfer of articles from the fluted conveyor device to a processing station or to other conveyor devices, it can be necessary to change the position of the articles in the flutes through transverse axial movement or displacement.

A device is known from the prior art for rolling rod-shaped articles of the tobacco-processing industry according to the applicant's DE 37 05 627 A1 in which the articles in the flutes of a fluted drum are displaced transverse axially by rolling between a rolling surface in a flute of the fluted drum and a counterrolling surface, whereby rolling surface and counterrolling surface move in opposite directions. The axis of the respectively rotating article thereby remains fixed to the axis of the rotary drum. The fixed rolling according to DE 37 05 627 A1 renders possible an optical examination along the circumference of the articles.

GB 2 110 917 A discloses a filter tipping machine in which cigarettes and filters are fed to a fluted drum with broad flutes respectively in two different positions in the wide flutes, whereby the wide flutes are indented at the position of the cigarettes. The filters, which project further out of the flutes at their position in the flutes with respect to the cigarettes, are rolled by a rolling block in the flutes to the position of the cigarettes, where they fall into the indentation in which the cigarettes are located.

### SUMMARY OF THE INVENTION

The present invention provides a transverse axial position change of the articles in the flutes of a conveyor drum or of a conveyor belt in a simple manner. In this way, the mechanical stress on the articles should be kept low.

The present invention is directed to a device for the transverse axial conveyance of rod-shaped articles of the tobacco-processing industry. The device comprises at least one fluted conveyor device with flutes for the articles, such that the width of the flutes is greater than the diameter of the articles. The flutes respectively have at least one suction boring that can be acted on with a vacuum for holding the articles by a vacuum at a position in the flute, in that a cover device is provided in order to form a chamber in interaction with a flute. In this way, before or after the formation of the chamber, a second suction boring, in particular, leading or trailing the article transverse axially in the conveyor direction, can be acted on with a vacuum at the chamber.

With the device according to the invention, after the transfer from a conveyor device, an article conveyed transverse axially is held by a vacuum at a first position in a flute or seat of a fluted drum or a fluted belt, in particular, adjacent to a ridge delimiting the flute, whereby a vacuum prevailing, e.g., in an interior of the fluted conveyor device is applied at one or more suction borings in the flute at the first position of the article. For the transverse axial position change of the article in the flute, the flute is covered by a cover device so that a chamber is formed. The height of the chamber is preferably greater than the article diameter, so that the article is not clamped through the covering by the cover device and therefore is not mechanically stressed.

The position change of the article is effected in that a vacuum is generated in the free part of the chamber or the broadened flute through a second suction boring, through which vacuum the article is suctioned to this side of the chamber or the flute. The chamber is thereby sealed at least so well that a vacuum necessary for changing the position of the article in the chamber or flutes can be developed.

An advantageous embodiment of the device according to the invention lies in that the fluted conveyor device is embodied as a fluted drum or as a fluted belt.

To assist the position change, it is advantageous if a vacuum can be disconnected at the first suction boring after the formation of the chamber. In this manner in particular mechanical deformations of the fragile articles by the simultaneous application of a vacuum at two sides of the articles are avoided. Moreover, a lower vacuum supply is thus possible. The application and disconnection of a vacuum at the suction borings occurs, e.g., in a manner known per se by control bodies arranged in the fluted conveyor device through which the suction borings along the conveyor path are sealed off by section and the suction air flow through the suction borings is interrupted. Through the simultaneous disconnection of the vacuum at the first suction boring and the application of the vacuum at the second suction boring after the chamber has been formed, articles are suctioned to a new position in the chamber in a particularly gentle manner.

In order to avoid the first suction boring being soiled in the course of further conveyance and articles being lost, it is provided that, after the chamber is opened, the vacuum is disconnected at the first suction boring and is applied at the second suction boring.

In a preferred, particularly simple embodiment, the cover device is embodied as a fixed, in particular flat cover body. The ridges between the flutes of the fluted conveyor device thereby preferably have a height corresponding at least to the diameter of the articles. Through this the number of movable parts is kept low, such that the flutes of the fluted conveyor device are conveyed along a conveyor path past a fixed cover body, e.g., a sheet-metal guide or a stable, flat guide rail. Since the ridges between the flutes of the fluted conveyor device have a height that corresponds at least to the diameter of the articles, the articles lie completely in the flutes.

The fluted conveyor device and the flat cover body are spaced such that the ridges of the fluted conveyor device essentially fit tightly to the cover body. In order to achieve an efficient position change of the articles in the chamber formed, it is in particular advantageous if the second suction boring is embodied respectively in the flutes of the fluted conveyor device. Through this second suction boring a vacuum is applied in the chamber and the articles are held in the flute after the transverse axial position change during further conveyance.

In a further development of the device according to the invention, the cover device is embodied as a fluted carrier, in particular as a conveyor drum or conveyor belt, whereby the chamber can be formed by a flute of the fluted carrier and a flute of the fluted conveyor device. The flutes of the fluted carrier thereby preferably have essentially the same width as the flutes of the fluted conveyor device. The sum of the height of the ridges on the fluted conveyor device and on the fluted carrier is hereby preferably at least the same as or greater than an article diameter. This embodiment is advantageous when, e.g., the ridges between the flutes of the fluted conveyor device are smaller than the article diameter, or when the transverse axial position change of the articles in the chamber involves a transfer of the articles to the fluted carrier.

In an advantageous further development of the device according to the invention, for a transfer of the articles to the fluted carrier, the second suction boring is respectively embodied in the flutes of the fluted carrier. The suction borings are preferably arranged at the position in the chamber that the articles occupy after the transverse axial position change. Through this a further conveyance of the articles on the fluted carrier is also rendered possible.

If respectively at least one second suction boring for applying a vacuum is provided in the flutes both of the fluted conveyor device and of the cover device, optionally further conveying the articles in the fluted conveyor device or in the fluted carrier is possible. The selection of the further conveyance can be made, e.g., through position change or exchange of the control bodies in the fluted conveyor device or in the fluted carrier.

The present invention is directed to a method for conveying transverse axially rod-shaped articles of the tobacco-processing industry, such that articles are conveyed respectively in flutes of a fluted conveyor device. The width of the flutes is greater than the diameter of the articles and the articles are held in the flute by a vacuum applied at a suction boring of the flute, which is further developed in that
a flute with an article is moved to a cover device,
a chamber is formed in interaction of the cover device with the flute, and
before or after the formation of the chamber a vacuum is applied at a second suction boring, in particular transverse axially leading or trailing the article in the conveyor direction, so that the transverse axial position of the article in the chamber is changed.

Through the method according to the invention, the mechanical stressing of the articles during the transverse axial position change is kept small.

In order to keep the first suction boring from becoming soiled after the position change of the articles, it is proposed that the vacuum applied to the first suction boring is disconnected after the chamber is formed.

With the method according to the invention, the chamber is formed by a fixed, in particular flat, cover body or by flutes of a fluted carrier, in particular a conveyor drum or conveyor belt, as a cover device.

In particular a further suction boring of the flute of the fluted conveyor device is acted on with a vacuum as a second suction boring. The articles are advantageously conveyed in the flutes of the fluted conveyor device after the chamber is opened.

According to an alternative embodiment of the method, a suction boring of the flute of the fluted carrier as a second suction boring is acted on with a vacuum. Through this the articles are conveyed in the flutes of the fluted carrier after the chamber is opened. The second suction boring hereby serves both to generate a vacuum in the chamber and to hold the article during further conveyance.

In order to transfer articles after the transverse axial position change either to a further conveyor device or to a processing station, it is provided that, after the position change of the article, the chamber is opened through the spacing of the flute of the fluted conveyor device and of the cover device forming the chamber. In this manner, after the position change the article is conveyed further in a flute of the fluted conveyor device or in a flute of the fluted carrier and is transferred at a further point of the conveyor path to a further conveyor device or to a processing station.

A particularly preferred embodiment of the method according to the invention lies in that the transverse axial position change of the articles in the chamber is effected exclusively by acting on the chamber with a vacuum via at least one second suction boring. Through this measure the mechanical stressing of the articles during the position change is reduced to a minimum.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 sectionally represents of an exemplary embodiment of a device according to the invention with a fixed flat cover body;

FIG. 2 sectionally represents of another exemplary embodiment of a device according to the invention; and

FIG. 3 sectionally represents of an exemplary embodiment of a device according to the invention with transfer to a fluted carrier.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

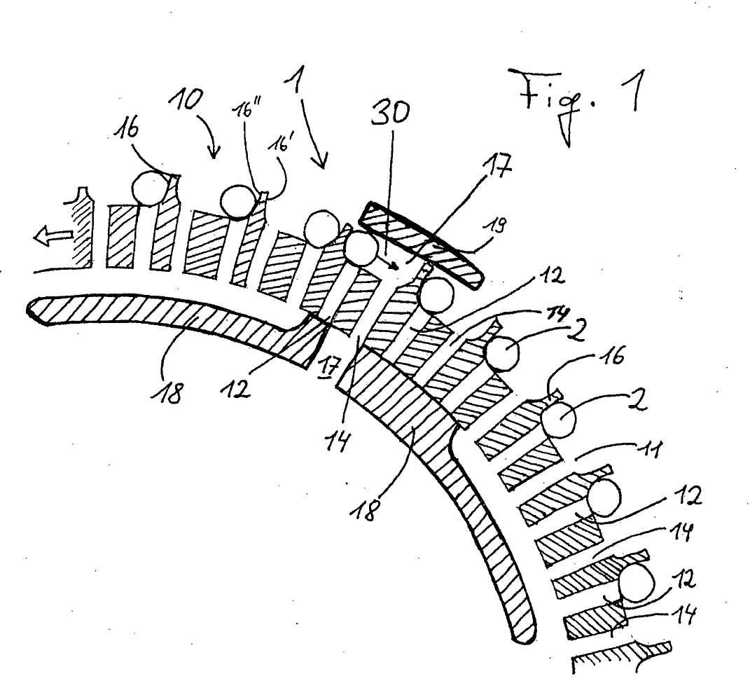

FIG. 1 shows a diagrammatic sectional representation through a device 1 according to the invention with a fixed cover body 19 as a cover device. A fluted drum 10 has flutes 11 which are separated by ridges 16. The height of the ridges 16 corresponds to the diameter of an article 2. The fluted drum 10 rotates in the arrow direction indicated. Each of the flutes 11 of the fluted drum 10 has two suction borings 12, 14, which are connected to a vacuum 17 inside the fluted drum 10.

In the exemplary embodiment in FIG. 1, the articles 2 are first in a position on the leading ridge surface 16′ of a flute 11 in the conveyor direction. The articles 2 are held in the position by a vacuum 17 that is applied via suction borings 12. In the course of the conveyance, the flutes 11 are conveyed into a section in which a cover body 19 with a flat underside is arranged in a fixed manner. If the flute 11 is located under the cover body 19, a chamber 30 is formed between the leading ridge surface 16′ or the article 2, the trailing ridge surface 16″ of a flute 11 and the cover body 19. The chamber 30 is sealed laterally, i.e., in the longitudinal axial direction of the article 2, by sealing surfaces of the cover body 19 or guides or the like not shown here. The vacuum 17 is applied in the free part of the chamber 30 via the suction boring 14. At the same time, the connection of the suction boring 12 at the position of the article 2 with the interior of the fluted drum 10 with the vacuum 17 is interrupted by a second control body 18.

The vacuum 17 prevailing in the free part of the chamber 30 acts on the article 2 so that the article 2 is moved in the chamber 30 into the rear position via the suction boring 14 at the trailing ridge surface 16″ of the flute 11. In the course of the further conveyance of the fluted drum 10, the article 2 is held in the flute 11 by a vacuum 17 via suction borings 14 at the trailing ridge surface 16′.

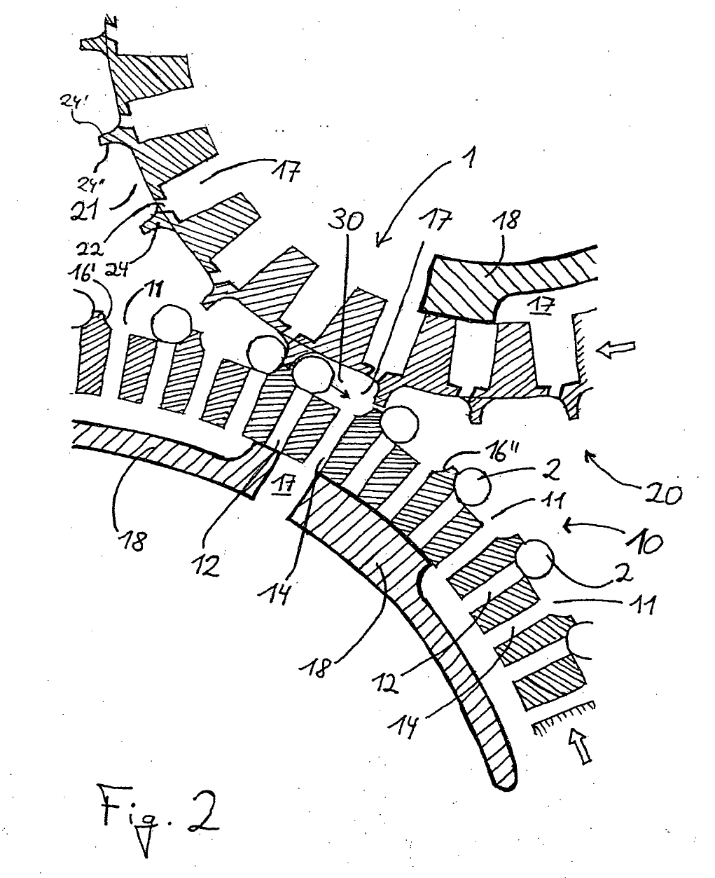

FIG. 2 shows a diagrammatic sectional representation through another exemplary embodiment of a device 1 according to the invention. As in the exemplary embodiment according to FIG. 1, a fluted drum 10 is provided with flutes 11 in which articles 2 are conveyed on the leading side of the flutes 11 or on the leading ridge surface 16′ of the flutes 11 in the conveyor direction (arrow direction).

In this exemplary embodiment, the cover device is another fluted drum 20, the flutes 21 of which have the same width or geometrical dimensions as the flutes 11 of the fluted drum 10. The spacing of the axes of the two fluted drums 10, 20 is selected to be equal to the sum of the radii of the fluted drums 10, 20.

In the area of the approach, the flutes 11, 21 of the fluted drums 10, 20 together with their ridges 16, 24 and side walls (not shown) form a chamber 30. The flutes 11 of the fluted drum 10 are provided with suction borings 12, 14, which are acted on with the vacuum 17 prevailing in the interior of the fluted drum 10. Suction borings 22 are arranged in the flutes 21 of the second fluted drum 20 in the trailing area, via which suction borings a vacuum 17 prevailing in the interior of the fluted drum 20 is likewise applied in the chamber 30.

After the formation of a chamber 30, the vacuum 17 is interrupted respectively at the leading suction boring 12 of the flute 11 by a fixed control body 18 in the interior of the fluted drum 10 and applied at the trailing suction boring 14. At the same time, the vacuum 17 is respectively applied to the suction boring 22 in the fluted drum 20 in the free part of the chamber 30. In this manner, the article 2 is moved in the arrow direction from the first position at the leading ridge surface 16′ into a new position at the trailing ridge surface 16″.

After the position change of the article 2, the chamber 30 is opened through further movement of the flutes 11, 21 of the fluted drums 10, 20 and the article 2 is conveyed further on the trailing ridge surface 16″ of the flute 11 of the fluted drum 10, whereby the article 2 is held by the vacuum 17 applied at the suction boring 14.

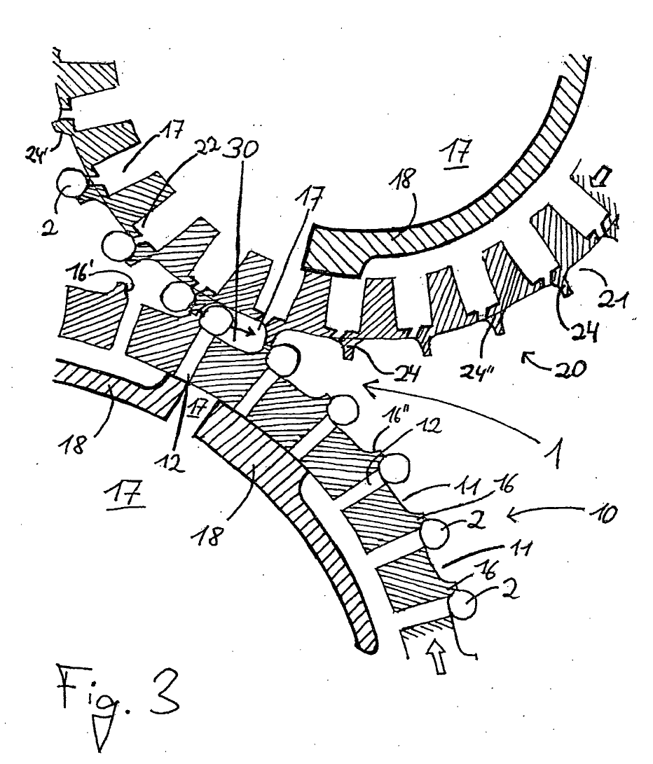

FIG. 3 shows a diagrammatic sectional drawing of an exemplary embodiment of a device 1 with transfer of conveyed articles 2 to a fluted drum 20. In contrast to the exemplary embodiment in FIG. 2, the flutes 11 of the fluted drum 10 have only leading suction borings 12, through which the articles 2 are held during the conveyance before the formation of the chamber 30.

The flutes 21 of the fluted drum 20 have suction borings 22 on the trailing ridge surfaces 24″. As in the exemplary embodiment according to FIG. 2, a chamber 30 is formed in interaction of the moved flutes 11, 21. After the formation of the chamber 30, the vacuum 17, by which the article 2 is held at the leading ridge surface 16′ of the flute 11, is disconnected via a control body 18 in the fluted drum 10. In the free part of the chamber 30 the suction boring 22 is acted on with the vacuum 17 prevailing in the interior of the fluted drum 20, so that the article 2 is moved in the direction of the suction boring 22. The fluted drum 20 has a control body 18 for the control or switching of the vacuum.

Since the flute 11 of the fluted drum 10 has no suction boring on the trailing ridge surface 16″, after the position change the article 2 is held in the flute 21 of the fluted drum 20 and conveyed further in the fluted drum 20 on the trailing ridge surface 24″ by the vacuum 17 at the suction boring 22.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

List of Reference Numbers

1 Conveyor device
2 Rod-shaped article
10 Fluted drum
11 Flute
12, 14 Suction boring
16 Ridge
16′ Leading ridge surface
16″ Trailing ridge surface
17 Vacuum
18 Control body
19 Cover body
20 Fluted drum
21 Flute
22 Suction boring
24 Ridge
24′ Leading ridge surface
24″ Trailing ridge surface
30 Chamber

What is claimed:

1. A device for conveying transverse axially rod-shaped articles of the tobacco-processing industry, comprising at least one fluted conveyor device with flutes for the articles, whereby the width of the flutes is greater than the diameter of the articles and the flutes respectively have at least one suction boring that can be acted on with a vacuum for holding the articles by a vacuum at a position in the flute, wherein a cover device is provided in order to form a chamber in interaction with a flute, whereby, before or after the formation of the chamber, a second suction boring, in particular leading or trailing the article transverse axially in the conveyor direction, can be acted on with a vacuum.

2. The device according to claim 1, wherein the fluted conveyor device is embodied as a fluted drum or as a fluted belt.

3. The device according to claim 1, wherein the vacuum at the first suction boring can be disconnected after the formation of the chamber.

4. The device according to claim 1, wherein after the chamber is opened the vacuum is disconnected at the first suction boring and applied at the second suction boring.

5. The device according to claim 1, wherein the cover device is embodied as a fixed, in particular flat cover body.

6. The device according to claim 1, wherein the second suction boring is respectively embodied in the flutes of the fluted conveyor device.

7. The device according to claim 1, wherein the cover device is embodied as a fluted carrier, in particular conveyor drum or conveyor belt, whereby the chamber can be embodied by a flute of the fluted carrier and a flute of the fluted conveyor device.

8. The device according to claim 7, wherein the second suction boring is embodied respectively in the flutes of the fluted carrier.

9. A method for the transverse axial conveyance of rod-shaped articles of the tobacco-processing industry, whereby articles are conveyed in flutes of a fluted conveyor device, whereby the width of the flutes is greater than the diameter of the articles and the articles are held in the flute by a vacuum applied at a suction boring of the flute, wherein
a flute with an article is moved to a cover device,
a chamber is formed in interaction of the cover device with the flute, and
before or after the formation of the chamber, a vacuum is applied at a second suction boring, in particular leading or trailing the article, so that the transverse axial position of the article in the chamber is changed.

10. The method according to claim 9, wherein the vacuum applied at the first suction boring is disconnected after the chamber is formed.

11. The method according to claim 9, wherein the chamber is formed as a cover device by a fixed in particular flat cover body or by flutes of a fluted carrier, in particular a conveyor drum or a conveyor belt.

12. The method according to claim 9, wherein a further suction boring of the flute of the fluted conveyor device is acted on with a vacuum as a second suction boring.

13. The method according to claim 12, wherein the articles are conveyed in the flutes of the fluted conveyor device after the chamber is opened.

14. The method according to claim 11, wherein a suction boring of the flute of the fluted carrier is acted on with a vacuum as a second suction boring.

15. The method according to claim 14, wherein the articles are conveyed in the flutes of the fluted carrier after the chamber is opened.

16. The method according to claim 9, wherein the transverse axial position change of the articles in the chamber is effected exclusively by acting on the chamber with a vacuum via at least one second suction boring.
